(19) United States
(12) Patent Application Publication
(10) Pub. No.: US 2010/0044903 A1
(43) Pub. Date: Feb. 25, 2010

(54) AUTOMATED INFILTRANT TRANSFER APPARATUS AND METHOD

(75) Inventors: Lawrence J. Rhoades, Pittsburgh, PA (US); Anita Hancox, Gibsonia, PA (US); John Y.P. Rhoades, (US)

Correspondence Address: BLYNN L. SHIDELER;THE BLK LAW GROUP, 3500 BROKKTREE ROAD, SUITE 200, WEXFORD, PA, 15090, US

(73) Assignee: The ExOne Company, Irwin, PA (US)

(21) Appl. No.: 12/546,295

(22) Filed: Aug. 24, 2009

Related U.S. Application Data
(63) Continuation of application No. PCT/US08/54876, filed on Feb. 25, 2008.
(60) Provisional application No. 60/891,290, filed on Feb. 23, 2007.
(60) Provisional application No. 60/981,303, filed on Oct. 19, 2007.

(51) Int. Cl. B28B 1/08; B27N 3/00; D04H 1/64; A23G 1/20; B41J 2/01

(52) U.S. Cl. 264/69; 264/109; 264/128; 264/308; 425/218; 347/1

(57) ABSTRACT

An apparatus provides a method for transferring infiltrant to a 3D printed article comprising the steps of (i) calculating the amount of infiltrant based in part upon the particulars of the 3D printed articles; (ii) dispensing the calculated amount of infiltrant to a scale from an infiltrant dispenser through a controller; (iii) weighing the dispensed infiltrant during the dispensing; providing the controller with a signal of the weighed dispensed infiltrant; and (iv) automatically stopping the infiltrant dispenser through the controller as the weighed infiltrant reaches the calculated amount of infiltrant.

### RELATED APPLICATIONS

This application is a continuation of international application PCT/US08/54876 entitled “Automated Infiltrant Transfer Apparatus and Method.” International application PCT/US08/54876 claims the benefit of provisional patent application 60/891,290 filed Feb. 23, 2007 entitled “Automated Vibratory Powdered Infiltrant Transfer Apparatus and Method.”

### BACKGROUND

1. Field of the Invention

The present invention relates to an automated infiltrant transfer apparatus and method, in particular to an automated powdered infiltrant transfer apparatus and method for three dimensional printed articles.

2. Background Information

Three-dimensional printing (3D printing) is a subdivision of the rapid prototyping technology that was developed at the Massachusetts Institute of Technology (MIT) at for the rapid and flexible production of prototype parts, end-use parts, and tools directly from a CAD model. Three Dimensional Printing, or 3D Printing, has unprecedented flexibility. It can create parts of any geometry, and out of any material, including ceramics, metals, polymers and composites. Furthermore, it can exercise local control over the material composition, microstructure, and surface texture. 3D printers are generally faster, more affordable and easier to use than other rapid prototyping technologies. This technology is marketed commercially by ExOne Company.

Three Dimensional Printing functions by building parts in layers. From a computer (CAD) model of the desired part, a slicing algorithm draws detailed information for every layer. Each layer begins with a thin distribution of powder spread over the surface of a powder bed, such as gold powder for dental copings. Using a technology similar to ink-jet printing, a binder material selectively joins particles where the object is to be formed. A piston that supports the powder bed and the part-in-progress lowers so that the next powder layer can be spread and selectively joined. This layer-by-layer process repeats until the part is completed. Following a heat treatment, unbound powder is removed, leaving the (semi) fabricated part, also called a green part within this application. The sequence of operations is depicted in FIG. 1.

The Three Dimensional Printing process combines powders and binders with unprecedented geometric flexibility. The support gained from the powder bed means that overhangs, undercuts and internal volumes can be created (as long as there is a hole for the loose powder to escape). Three Dimensional Printing can form any material that can be obtained as a powder—which is just about any material. Further, because different materials can be dispensed by different print heads, 3D Printing can exercise control over local material composition. Material can be in a liquid carrier, or it can be applied as molten matter. The proper placement of droplets can be used to create surfaces of controlled texture and to control the internal microstructure of the printed part.

The Three Dimensional Printing process surpasses conventional powder processing because while the Three Dimensional Printing components rival the performance of those made by conventional methods, there are no tooling or geometric limitations with Three Dimensional Printing. Because of its great flexibility in handling a wide range of materials and because of the unique ability to locally tailor the material composition, Three Dimensional Printing offers potential for the direct manufacture of structural components with unique microstructures and capabilities. Three Dimensional Printing is also readily scaled in production rate through the use of multiple nozzle technology which has been commercially developed for printing images on paper.

The 3D-Printing rapid prototyping process is described in more detail in U.S. patents Sachs et al U.S. Pat. No. 5,204,055 (issued Apr. 20, 1993), Cima et al. U.S. Pat. No. 5,387,380 (issued Feb. 7, 1995), and Sachs U.S. Pat. No. 6,036,777 (issued Mar. 14, 2000) which are herein incorporated by reference. See also U.S. Pat. Nos. 5,340,656 and 5,387,380 which are herein incorporated by reference.

Depending on the intended use of the article, the three dimensional printed article is generally a porous or low density structure and it may thereafter be infiltrated with a suitable infiltrant, such as a polymer, or a metal having a liquidus temperature lower than that of the three dimensional printed article which can be moved into. The porous article that is infiltrated with another material, such as a lower melting temperature metal, will give a fully dense article with desirable properties.

For example U.S. Pat. No. 6,655,481 describes the preparation of a drill bit body by Three Dimensional Printing wherein “particulate material is dispersed into a layer, and the particles in selected areas of the layer affixed to one another by a polymeric adhesive or nonpolymeric binder (e.g., water-glass). Due to the selective deposition of binder over the layer of particulate material in order to define a desired solid structure, this type of layered-manufacturing is typically referred to as “3D-Printing”. The bit body may then be placed in a furnace where it may be preheated to substantially remove the bonding agent. In such instances, certain metal powders may be at least preliminarily sintered or fused, such sintering to be enhanced or completed, if necessary, in a later furnacing operation. If a powdered metal coated with bonding agent or metal intermixed with bonding agent is employed as the particulate material as mentioned above, the resulting bit body is a porous and permeable metal mass akin to a sponge or an open-celled foam, which can be imbibed with suitable hardenable infiltrants, either metallic, nonmetallic, or a combination thereof, to complete the bit body. If an infiltrant in liquid form at room temperature (e.g., certain polymers) is employed, the bit may be mass infiltrated via capillary action, gravity, and/or pressurized flow at room temperature. If an infiltrant that is solid at room temperature is employed, the bit may be mass infiltrated by capillary action, gravity, and/or pressurized flow while the infiltrant is heated, such as by a furnace or an induction coil.”

The ExOne Company has utilized the three dimensional printing process for the rapid formation of dental copings. Dental copings are structures, typically metal, that fit onto the patients prepared tooth that can form the basis for a bridge or similar dental structure. As described above the 3D printed porous coping (also called a green coping) will need to be filled with infiltrant to obtain the desired final mechanical properties. Currently a specified amount of infiltrant powder, typically gold alloy, must be dispensed, weighed and then transferred into the green coping. The current procedure is as follows:
1. Obtain target weight of infiltrant. (This value is calculated based upon the specifics of the 3D printed green coping and the properties of the infiltrant.)
2. Tare a folded weigh paper on a balance, typically the size and weight of a business card with folds to assist material transfer.
3. Using a scoop, transfer powder from a container of infiltrant powder, e.g. gold powder, to the weigh paper.
4. Weigh to ±1% of the target weight.
5. Carefully transfer the infiltrant from the weigh paper into the green coping. In some cases, it is necessary to compact the infiltrant powder as it is being dispensed so that it may fit within the green coping. The folded paper carrier may be used to spread and compact the infiltrant within the green coping.

This procedure takes 3 to 5 minutes per coping. In addition to the time consuming nature of the process, there can be material loss moving from the weigh paper to the coping. Where expensive infiltrants, like gold are used, this material loss can become expensive. There is a need in the art to improve this process for powdered infiltrants.

### SUMMARY OF THE INVENTION

One embodiment of the present invention provides a method for transferring infiltrant to a 3D printed article comprising the steps of (i) calculating the amount of infiltrant based in part upon the particulars of the 3D printed articles; (ii) dispensing the calculated amount of infiltrant to a scale from an infiltrant dispenser through a controller; (iii) weighing the dispensed infiltrant during the dispensing; (iv) providing the controller with a signal of the weighed dispensed infiltrant; and (v) automatically stopping the infiltrant dispenser through the controller as the weighed infiltrant reaches the calculated amount of infiltrant.

In one aspect of the invention provides an apparatus for transferring infiltrant to an article comprising: (i) a controller for controlling the system for dispensing a calculating amount of infiltrant which is calculated based in part upon the particulars of the article; (ii) an infiltrant dispenser coupled to the controller for dispensing the calculated amount of infiltrant based upon input from the controller; and (iii) a scale weighing the dispensed infiltrant during the dispensing and configured to provide the controller with a signal of the weighed dispensed infiltrant, wherein the controller is configured to automatically stop the infiltrant dispenser as the weighed infiltrant reaches the calculated amount of infiltrant.

One embodiment of the present invention provides a vibratory apparatus for transferring powdered infiltrant to an article comprises (i) an infiltrant dispenser trough for receiving and dispensing powdered infiltrant; (ii) a dispensing orifice at a dispensing end of the trough; (iii) a sealing member selectively sealing the orifice and configured for oscillating motion into and out of engagement with the dispensing orifice; (iv) a vibration mechanism coupled to the dispenser trough configured to selectively vibrate the trough, wherein vibration of the trough causes the oscillation motion of the sealing member; and (v) a stop coupled to the trough that limits magnitude of the oscillation of the sealing member.

Another aspect of the present invention provides a method for transferring powdered infiltrant to a 3D printed article comprising the steps of (i) supplying powdered infiltrant to a vibratory trough with a dispensing orifice and a sealing member selectively sealing the orifice that configured for oscillating motion into and out of engagement with the dispensing orifice with the vibration of the trough; (ii) vibrating the trough to cause dispensing of infiltrant from the infiltrant dispenser; and (iii) weighing the dispensed infiltrant during the dispensing.

These and other advantages of the present invention will be clarified in the brief description of the preferred embodiment taken together with the drawings in which like reference numerals represent like elements throughout.

### BRIEF DESCRIPTION OF THE DRAWINGS

FIG. 1 is a schematic view of a conventional 3D printing process;

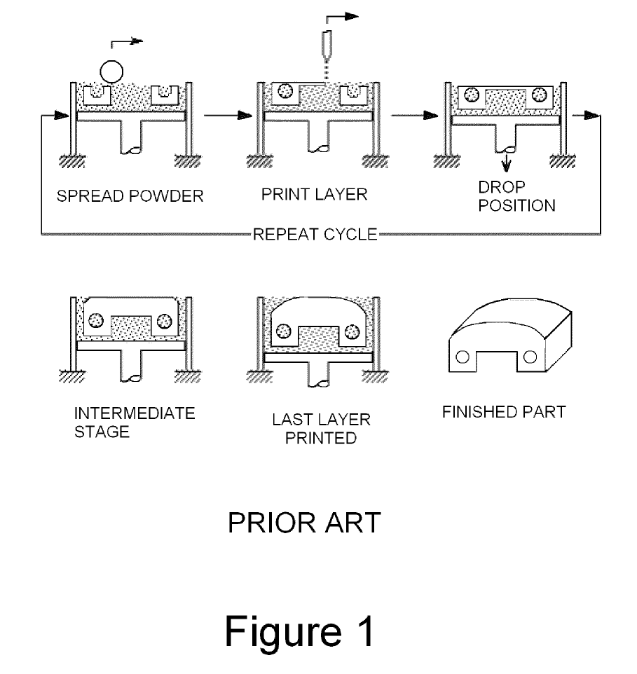

FIG. 2 is a schematic view of the automated infiltrant transfer apparatus according to one aspect of the present invention;

FIG. 3 is a schematic partial section view of a automated vibratory powdered infiltrant transfer apparatus according to one embodiment of the present invention; and

FIG. 4 is an image of one implementation of the transfer apparatus of FIG. 3.

### DESCRIPTION OF THE PREFERRED EMBODIMENTS

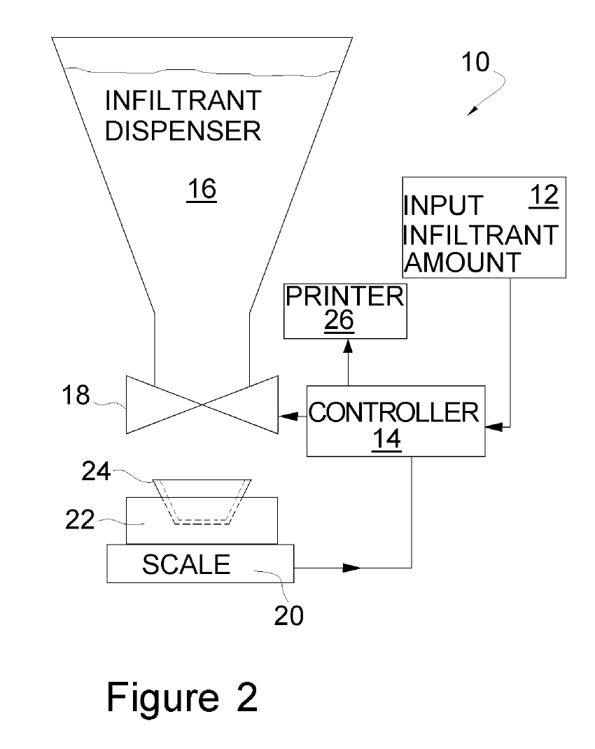

FIG. 2 a schematic view of the automated infiltrant transfer apparatus 10 according to one aspect of the present invention. The present invention is disclosed as being associated with automatically supplying infiltrant for 3D printed articles 24, such as dental copings, however it is possible to use the infiltrant transfer apparatus 10 with any article for which infiltrant is being provided.

The present invention provides for a mechanism 12 for inputting the amount of infiltrant, called a calculated infiltrant amount, which is associated with each particular article 24. It will be appreciated that the amounts will vary for each independent article 24, and in the field of dental copings, each article 24 will be unique. The calculated infiltrant amount will be determined based upon the parameters of the article 24. One aspect of the present invention calculates the amount of binder used in the 3D printing process and utilizes this parameter to calculate the amount of infiltrant that is needed. The amount of binder utilized can be easily measured during the manufacturing process and will provide a direct measurement of the article 24, as opposed to utilizing the desired article 24 configuration from the controlling CAD program. The inputting mechanism 12 may be a keyboard or may be a coupling to a controller from the 3D printing machine that is measuring the amount of binder used, whereby the system 10 is further automated. Other parameters of the article 24 could be used to determine the calculated infiltrate amount such as the CAD file, the weight of the article, and the weight of the remaining material in the build box or the like.

A controller 14, also called a processor, is used to control the system 10 and received the calculated amount from the input mechanism 12. Any conventional processor 14 can be utilized as appreciated by those of ordinary skill in the art. The controller 14 may include a display, and other user controls as necessary for operator interaction and control of the system 10.

An infiltrant dispenser 16 is provided with a dispensing mechanism 18 coupled to the controller 14. The dispenser 16 may be a gravity feed hopper (as schematically shown), a vibratory feeder tray, a fluid holding tank (where the infiltrant is liquid), a conveying or extrusion tube, or other known article handling dispensers. The dispensing mechanism 18 may be an actuated slide gate, valve or the like at the bottom of a hopper. Alternatively the mechanism may be an extrusion screw, a metering piston/plunger, or controls for a vibratory feeder, or other conventional metering dispenser controls that are known in the art. The operation of the mechanism 18 and hence the control of the dispenser 16 is controlled by the controller 14.

The present invention operates effectively with any known infiltrant, however it is particularly well suited for powdered metal infiltrants such as gold powder having particle sizes less than 150 microns.

The dispenser 16 is configured to dispense directly into a 3D printed article 24 positioned within a carrier 22 that is supported upon a scale 20. The scale 20 is coupled to the controller 14 and configured to generate a signal indicative of the weight of the dispensed infiltrant (i.e. the change in the weight of the carrier 22 and article 24 from the beginning of the filling cycle).

The carrier 22 may hold a plurality of articles 24 is separate locations on the carrier 22 which may include a displaceable media to receive and support the articles 24. The system 10 may be automated with a pick and place unit for placing the carrier 22 and article(s) 24 onto and off of the scale 20 and for indexing the carrier to the next article 24 filling position if multiple articles 24 are provided in a single carrier 22. The ability of the scale 20 to zero out between cycles allows the carrier 22 to accommodate a plurality of articles 24. In such automated system 10 the articles 24 will have a selected predetermined position within the carrier 22 to assure proper positioning beneath the dispenser 16.

The articles 24 may be any article receiving infiltrant, but the present invention addresses the particular concerns of transferring infiltrant such as gold powder to dental copings.

The system 26 provides for a printer 26 to be coupled to the controller 14 so that a documented record of the infiltrant transfer can be obtained. The printer may be replaced with other display mechanism or transfer and recording medium as desired (i.e. the controller 26 may transfer an electronic record to a central archive).

The system 10 operates as follows to transfer infiltrant to an article 24, such as, in particular, a 3D printed article: There is a calculation of the amount of infiltrant for the article 12 based, at least in part, upon the particulars of the 3D printed article 24. This calculated infiltrant amount is supplied to the controller 14 through input 12. The article 24 within a carrier 22 is placed appropriately upon a scale 20 at the feeding outlet of the dispenser 16 and the scale will zero out such that only the change in weight will be sent to the controller 14 (although a record of the actual and change in weight of the carrier 22, articles 24 and infiltrant may be kept by the system 10). The controller 14 will actuate mechanism 18 for dispensing the calculated amount of infiltrant directly to the article 24 (which is in the carrier 22 and on the scale 20) from an infiltrant dispenser 16. The scale 20 will weigh the dispensed infiltrant during the dispensing and will provide the controller 14 with a signal of the weighed dispensed infiltrant. The controller 14 will automatically stop the mechanism 18 and thus the infiltrant dispenser 16 as the weighed infiltrant reaches the calculated amount of infiltrant. The present system provides an accuracy of +−5% of the calculated infiltrate amount by weight, preferably +−2% of the calculated amount by weight, and most preferably +−1% of the calculated amount by weight.

The method for transferring infiltrant to a 3D printed article 24 as shown has the infiltrant dispensed directly from the infiltrant dispenser 16 to the 3D printed article 24. However the automated system 10 provides advantages over the prior art even if the dispenser 16 dispenses upon an intermediate carrier, such as weigh paper, that is subsequently transferred to the article in a separate transfer step (manually or in a subsequent automated fashion). The preferred embodiment of this invention remains in the elimination of a subsequent infiltrant transfer step, if possible.

Certain dispensing parameters can be varied as needed to increase cycle time and/or accuracy of the process. For example, the rate of dispensing may be slowed as the weight of the dispensed infiltrant approaches the calculated amount, such that the stopping of the dispensing may occur more precisely at the calculated point.

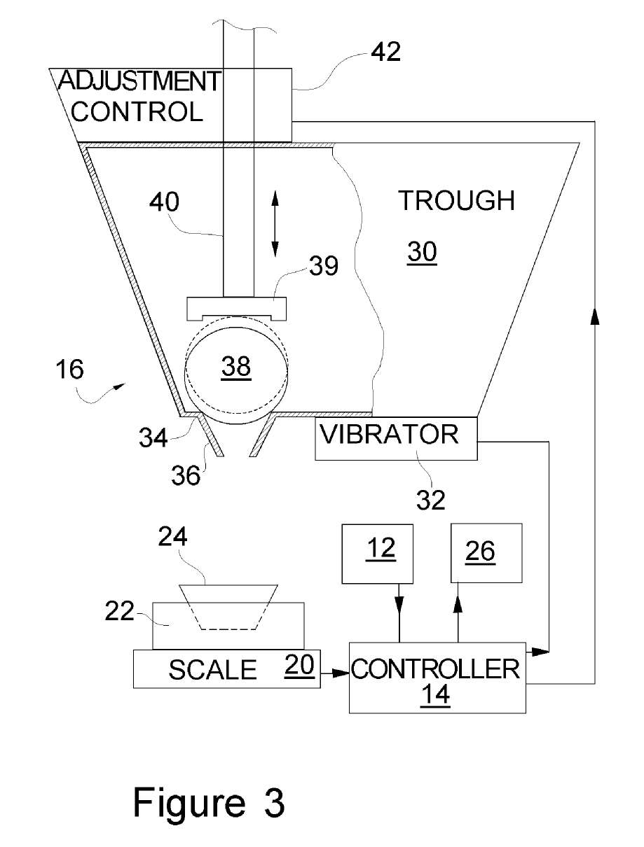

FIG. 3 illustrates a particular embodiment of the present invention suitable for dispensing powdered infiltrant material efficiently. In this embodiment the dispenser 16 includes a trough 30 that may be formed of stainless steel components. The trough 30 is a vibratory feeder and is vibrated by a conventional vibrator 32 controlled by the controller 12. The end of the trough 30 has a dispensing orifice 34 that leads to a flow directing channel 36, or funnel, for directing the infiltrant material to the articles 24 as shown. The orifice 34 is selectively sealed by a sealing member 38, shown in this embodiment in the form of a steel ball.

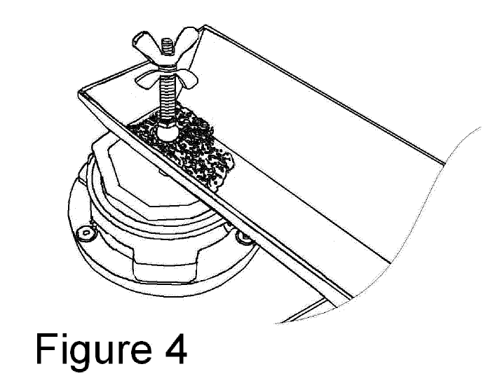

The steel ball of sealing member 38 is configured to oscillate into and out of engagement with the orifice 34 as the trough 30 is vibrated. A stop 39 is mounted to limit the maximum magnitude of the oscillation of the sealing member 38 by defining the vertical gap above the sealing member 38 when it is in the sealed position. The stop 39 is mounted on an adjustable rod 40, such as a threaded rod, that is adjustably positioned by an adjustment mechanism 42. The adjustment mechanism 42 may be controlled by the controller 12 to automatically set the gap to a calculated position as schematically illustrated in FIG. 3 or the mechanism 42 may be a manual adjustment as shown in the photo of FIG. 4.

The vibratory feeder embodiment of FIGS. 3 and 4 provides a simple and efficient powder infiltrant transfer apparatus. The oscillating sealing member 28 formed by the ball will result in an even flow of powdered infiltrant such as gold powder. Further the member 28 provides for rapid and effective shut off of the flow with the stopping of the vibration. The member 28 can be formed of a number of other shapes, such as an inverted cone shape that extends through the orifice 34 and still provides a seal to the orifice 34.

Although the present invention has been described with particularity herein, the scope of the present invention is not limited to the specific embodiment disclosed. It will be apparent to those of ordinary skill in the art that various modifications may be made to the present invention without departing from the spirit and scope thereof.

What is claimed is:

1. A method for transferring infiltrant to a 3D printed article comprising the steps of
(i) calculating the amount of infiltrant based in part upon the particulars of the 3D printed articles;
(ii) dispensing the calculated amount of infiltrant to a scale from an infiltrant dispenser through a controller;
(iii) weighing the dispensed infiltrant during the dispensing; providing the controller with a signal of the weighed dispensed infiltrant; and
(iv) automatically stopping the infiltrant dispenser through the controller as the weighed infiltrant reaches the calculated amount of infiltrant.

2. The method for transferring infiltrant to a 3D printed article according to claim 1 wherein the infiltrant is dispensed directly from the infiltrant dispenser to the 3D printed article.

3. The method for transferring infiltrant to a 3D printed article according to claim 1 wherein the calculating of the amount of infiltrant is based in part upon the amount of binder within the 3D printed article.

4. The method for transferring infiltrant to a 3D printed article according to claim 1 wherein the infiltrant is a powder material.

5. The method for transferring infiltrant to a 3D printed article according to claim 1 wherein the infiltrant is a powder metal material.

6. The method for transferring infiltrant to a 3D printed article according to claim 1 wherein the infiltrant is a powder gold material.

7. The method for transferring infiltrant to a 3D printed article according to claim 1 wherein the article is a dental coping.

8. The method for transferring infiltrant to a 3D printed article according to claim 1 wherein the rate of dispensing is slowed as the weight of the dispensed infiltrant approaches the calculated amount.

9. The method for transferring infiltrant to a 3D printed article according to claim 1 wherein the final weighed infiltrant dispensed is +−1% of the calculated weight of infiltrant.

10. The method for transferring infiltrant to a 3D printed article according to claim 1 wherein the infiltrant is a powder material having a particle size of less than 150 microns.

11. An apparatus for transferring infiltrant to an article comprising:
(i) a controller for controlling the system for dispensing a calculating amount of infiltrant which is calculated based in part upon the particulars of the article;
(ii) an infiltrant dispenser coupled to the controller for dispensing the calculated amount of infiltrant based upon input from the controller; and
(iii) a scale weighing the dispensed infiltrant during the dispensing and configured to provide the controller with a signal of the weighed dispensed infiltrant, wherein the controller is configured to automatically stop the infiltrant dispenser as the weighed infiltrant reaches the calculated amount of infiltrant.

12. The apparatus for transferring infiltrant to the article according to claim 11 wherein the infiltrant dispenser is configured whereby the infiltrant is dispensed directly from the infiltrant dispenser to the 3D printed article.

13. The apparatus for transferring infiltrant to the article according to claim 11 wherein article is a 3D printed article and the calculating of the amount of infiltrant is based in part upon the amount of binder within the 3D printed article.

14. The apparatus for transferring infiltrant to the article according to claim 11 wherein the infiltrant dispenser is configured to dispense a powder material.

15. The apparatus for transferring infiltrant to the article according to claim 11 wherein the controller is configured to control the dispenser whereby the rate of dispensing is slowed as the weight of the dispensed infiltrant approaches the calculated amount.

16. The apparatus for transferring infiltrant to the article according to claim 11 wherein the apparatus is configured whereby the final weighed infiltrant dispensed is +−1% of the calculated weight of infiltrant.

17. The apparatus for transferring infiltrant to the article according to claim 1 wherein the infiltrant dispenser is configured to dispense a powder material having a particle size of less than 150 microns.

18. An apparatus for transferring powdered infiltrant to a 3D printed article comprising:
(i) a controller for controlling the system for dispensing a calculating amount of powdered infiltrant which is calculated based in part upon the particulars of the article;
(ii) an infiltrant dispenser coupled to the controller for dispensing the calculated amount of powdered infiltrant based upon input from the controller; and
(iii) a scale weighing the dispensed infiltrant during the dispensing and configured to provide the controller with a signal of the weighed dispensed infiltrant, wherein the controller is configured to automatically stop the infiltrant dispenser as the weighed infiltrant reaches the calculated amount of infiltrant.

19. The apparatus for transferring powdered infiltrant to the article according to claim 18 wherein the controller is configured to control the dispenser whereby the rate of dispensing is slowed as the weight of the dispensed infiltrant approaches the calculated amount.

20. The apparatus for transferring powdered infiltrant to the article according to claim 19 wherein the apparatus is configured whereby the final weighed infiltrant dispensed is +−1% of the calculated weight of infiltrant.
